(19) United States
(12) Patent Application Publication
(10) Pub. No.: US 2021/0001989 A1
(43) Pub. Date: Jan. 7, 2021

(54) CARGO HOLD MODULE FOR AN AIRCRAFT

(71) Applicant: Jürgen Robert GRAFMÜLLER, München (DE)

(72) Inventor: Jürgen Robert GRAFMÜLLER, München (DE)

(21) Appl. No.: 16/920,006

(22) Filed: Jul. 2, 2020

(30) Foreign Application Priority Data
Jul. 2, 2019 (DE) 20 2019 103 637.0

(51) Int. Cl. B64D 11/06

(52) U.S. Cl. CPC B64D 11/0648; B64D 2011/0046; B64D 11/0604

(57) ABSTRACT

In a cargo hold module for an aircraft, in particular a passenger aircraft, with exterior dimensions that are adjusted to a respective cargo hold of the aircraft, and suitable for securing the cargo hold module in a predetermined position in a cargo hold of the aircraft, the cargo hold module has an accessway, via which it can be accessed from a cabin of the aircraft. The cargo hold module can be hooked up to onboard electrical systems of the aircraft for power, water and/or air supply. The cargo hold module has a massage facility with at least one massage table for treating passengers or crew.

### BACKGROUND OF THE INVENTION

### Field of the Invention

The invention relates to a cargo hold module for an aircraft, in particular a passenger aircraft, with exterior dimensions that are adjusted to a respective cargo hold of the aircraft, and with means that are suitable for securing the cargo hold module in a predetermined position in a cargo hold of the aircraft.

### Brief Description of the Related Art

Examples of known cargo hold modules for aircraft include cargo containers for luggage and other loads, which are most often stowed underneath a passenger cabin in the fuselage. These cargo containers or cargo hold modules are most often moved from a loading hatch to their predetermined position on rolling elements inside of the cargo hold. The latter are then secured and fixed in place with means supported for this purpose at the position inside of the cargo hold that most often results from the overall weight of the loaded cargo hold modules or cargo containers. In order to optimize space utilization, the side of these cargo containers or cargo hold modules facing the fuselage most often have at least one chamfered or partially chamfered side wall.

Since the cargo hold of an aircraft, apart from possible sleeping places for the flight crew, most often extends over almost the entire length of the fuselage underneath the passenger cabin, its volume is frequently not completely needed for cargo to be transported. This existing, unused empty space in the cargo hold has thus far not been put to a different use. Moreover, passengers are most often unable to move around enough during long-haul flights, and thus frequently become stressed, which is detrimental to the wellbeing of the passengers with increasing flight duration.

### SUMMARY OF THE INVENTION

Therefore, the object to the invention lies in making this most often present empty space in the cargo hold useful in some other way, in particular for passengers.

This object is achieved with a cargo hold module with the features in the independent claim(s). Further developments and advantageous embodiments of the cargo hold module are indicated in the dependent claim(s).

The cargo hold module for an aircraft, in particular a passenger aircraft, with exterior dimensions that are adjusted to a respective cargo hold of the aircraft, and with means that are suitable for securing the cargo hold module in a predetermined position in a cargo hold of the aircraft, is characterized in that the cargo hold module has an accessway via which it can be accessed from a cabin of the aircraft, that the cargo hold module can be hooked up to onboard electrical systems of the aircraft for power, water and/or air supply, and that the cargo hold module has a massage facility with at least one massage table for treating passengers or crew.

This cargo hold module thus makes it possible to repurpose the cargo hold for use by the passengers or crew, so as to provide an additional relaxation option. Once a predetermined flight altitude has been reached, passengers can move from the seat to be occupied during takeoff and landing through the accessway and into the cargo hold module with the massage facility, and be treated by appropriately trained professionals.

In order to give passengers and crewmembers alike as much privacy as possible during the massage treatment, the massage facility of the cargo hold module can have compartments that can be or are separated from each other. In another embodiment, the compartments can be separated both by means of permanently installed walls, sliding walls or curtains. Of these, curtains here offer a more flexible arrangement and ease of use. In addition, curtains are lightweight, which has a positive effect with regard to the vehicle load capacity and kerosene consumption of the aircraft.

In a further development, at least one section is therefore provided with a massage table, in particular one massage table per section. As a consequence, the best possible screening and privacy is ensured during treatment for the respective person to be treated.

In an advantageous embodiment, the massage facility comprises two massage tables, which are arranged head to head and transverse to a predetermined flight direction of the aircraft in the cargo hold module. A corresponding arrangement of massage tables transverse to the flight direction of the aircraft enables a compact construction of the cargo hold module that preferably extends over the entire width of the cargo hold, and hence an optimal space utilization.

It is here especially advantageous that the massage table or massage tables have a reclining surface with a distance from the floor of the cargo hold module that is greater than a part of the side wall that is chamfered toward the fuselage. As a consequence, the massage table can with one respective foot end be arranged above the chamfered side wall of the cargo hold module in a space-saving manner.

In order to also allow a person to be treated, in particular a person to be massaged, to have a comfortable posture even when lying on his or her stomach, it can further be provided that the massage table have a head hole at its head end, or that the massage tables each have a head hole at their head end. This prevents the head of the respective person from uncomfortably tilting during the massage.

A section of the massage facility can further comprise a shower cubicle. The shower cubicle allows someone to clean up before or after a massage. The shower cubicle is separated from the rest of the massage facility in a simple manner by a partition wall and door, and divided into a dry area and a wet area. The additional division into a dry area and wet area here also creates a changing room in the dry area of the shower cubicle that is separate from the rest of the massage facility. To prevent clothing placed in the dry area from getting wet while showering, another partition can be provided, for example in the form of a shower curtain. The shower cubicle can also be inserted into the cargo hold module as a prefabricated unit.

If a shower cubicle or some other washing option is provided, for example a washbasin, it is mandatory that a hookup for water supply and water disposal be provided in addition to the onboard electrical system for power and air supply.

Access to the cargo hold module is advantageously gained from above by way of a staircase. This staircase is then directly connected with the passenger cabin of the aircraft by way of a trapdoor, and allows direct access from the passenger cabin to the massage facility in the cargo hold module. In another embodiment, the staircase must be positioned in such a way as to be arranged below an aisle of the passenger cabin. Therefore, in an aircraft with a center aisle, the staircase is advantageously arranged centrally and in the longitudinal direction of the aircraft inside of the cargo hold module.

In a preferred embodiment, the staircase is additionally arranged between the shower cubicle and a lounge area. The staircase can then be arranged in an easy manner between two walls or handrails that border the staircase. A person using the staircase is then optimally secured on both sides, in particular when the aircraft gets into turbulence during the flight, which can lead to vibrations inside of the cargo hold module and passenger cabin.

In an advantageous embodiment, the lounge area can also be provided as an additional massage area. The lounge area here preferably has a massage chair, for example which enables foot massages. A conventional seat can here also be provided in place of a massage chair. Additional seats can be arranged in a center aisle between two useful halves of the massage facility of the cargo hold module. A first useful half is then comprised of the shower cubicle, accessway and lounge area, and a second useful half located opposite the first useful half as viewed from the center aisle is comprised of the two massage tables.

In addition, a storage space for various utensils, in particular in conjunction with utensils required for massages, can be provided underneath the staircase. As a result, the space within the cargo hold module existing beneath the accessway can also be optimally utilized. For example, utensils can include towels, massage oils, cremes, etc.

### BRIEF DESCRIPTION OF THE DRAWINGS

The drawing shows one exemplary embodiment of the invention, which can give rise to additional features essential to the invention. Shown on:

FIG. 1: is a top view of a cargo hold module according to the invention;

FIG. 2: is cross section through the cargo hold module according to the invention on FIG. 1;

FIG. 3: is a longitudinal section through the cargo hold module according to the invention on FIG. 1 and FIG. 2; and on

FIG. 4: is a perspective view of the cargo hold module according to the invention.

### DETAILED DESCRIPTION OF THE PREFERRED EMBODIMENTS

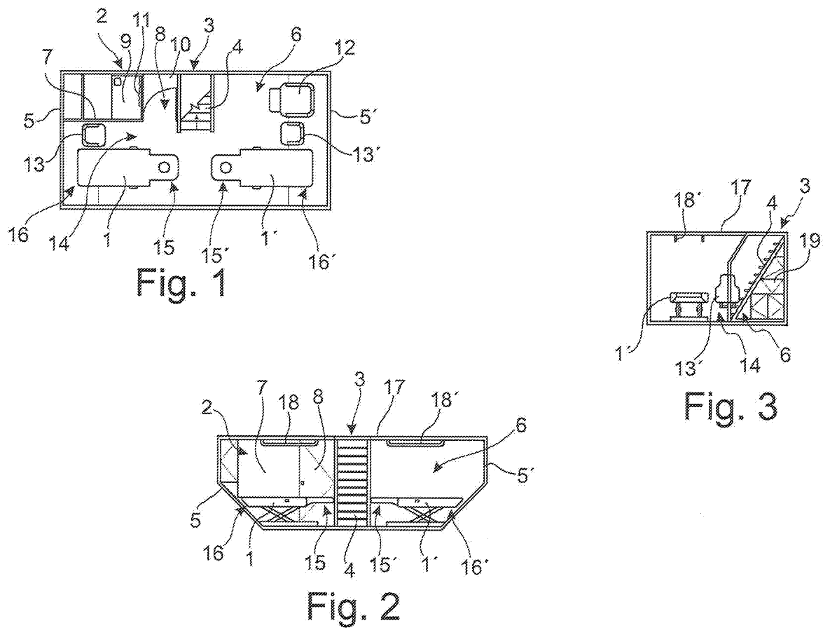

In particular the arrangement and distribution of essential parts of the massage facility are evident from the top view according to FIG. 1. Throughout the entire specification, indications such as longitudinal and transverse here always relate to the position of a fuselage or to a fuselage inside of which the cargo hold module is or can be arranged.

Essential parts of the cargo hold module include massage tables 1, 1′, the shower cubicle 2 and the accessway 3 to the cargo hold module. The accessway 3 to the cargo hold module is comprised of a staircase 4, which makes it possible to ascend or descend in the longitudinal direction of the cargo hold module. The staircase 4 is arranged between the side walls 5, 5′ of the cargo hold module, wherein the side walls 5, 5′ each face the fuselage given a cargo hold module arranged in a cargo hold of an aircraft. The shower cubicle 2 is arranged on the left side, and the lounge area 6 on the right side of the staircase 4.

The shower cubicle 2 is separated from the rest of the massage facility by means of a partition wall 7 and a door 8, and further divided into a wet area 9 and a dry area 10. The dry area 10 with the door 8 here directly adjoins the staircase 4, while the wet area 9 is arranged outside of the dry area 10. The wet area 9 and the dry area 10 are also separated from each other by a shower curtain 11. A massage seat 12 is arranged in the lounge area 6, which can be used for foot massages on the one hand, and is also there for people waiting on the other. Two additional seats 13, 13′ are arranged on the outside like a kind of center aisle 14. The center aisle 14 is arranged between a first useful half of the cargo hold module with the accessway 3, shower cubicle 2 and lounge area 6, as well as a second useful half with the massage tables 1, 1′.

The massage tables 1, 1′ are further arranged in the cargo hold module in such a way that one massage table 1 is arranged in the longitudinal direction to the left of the accessway 3, and one massage table 1′ is arranged in the longitudinal direction to the right of the accessway 3. The massage tables 1, 1′ are further arranged one opposite the other, and each face each other with head ends 15, 15′, wherein both massage tables 1, 1′ are spaced equidistantly apart from a center line of the cargo hold module. The distance between the massage tables 1, 1′ is here dimensioned so that their foot ends 16, 16′, just like the massage seat 12 and seats 13, 13′, are arranged above a chamfered section 5a, 5a′, and make optimal use of the space available in the cargo hold modules.

This arrangement of the foot ends 16, 16′ of the massage tables 1, 1′ also becomes clear in particular on FIG. 2, wherein the distance between the head ends 15, 15′ of the massage tables 1, 1′ rather precisely corresponds to the width of the staircase 4 of the accessway 3. As further evident from FIG. 2, handles 18, 18′ are arranged on a cover 17 of the cargo hold module.

FIG. 3 further shows that the handles 18, 18′ are arranged above the massage tables 1, 1′, and two handles 18, 18′ are allocated to each massage table 1, 1′. As evident from FIG. 3, storage spaces 19 for various utensils are provided under the staircase 4 of the accessway 3.

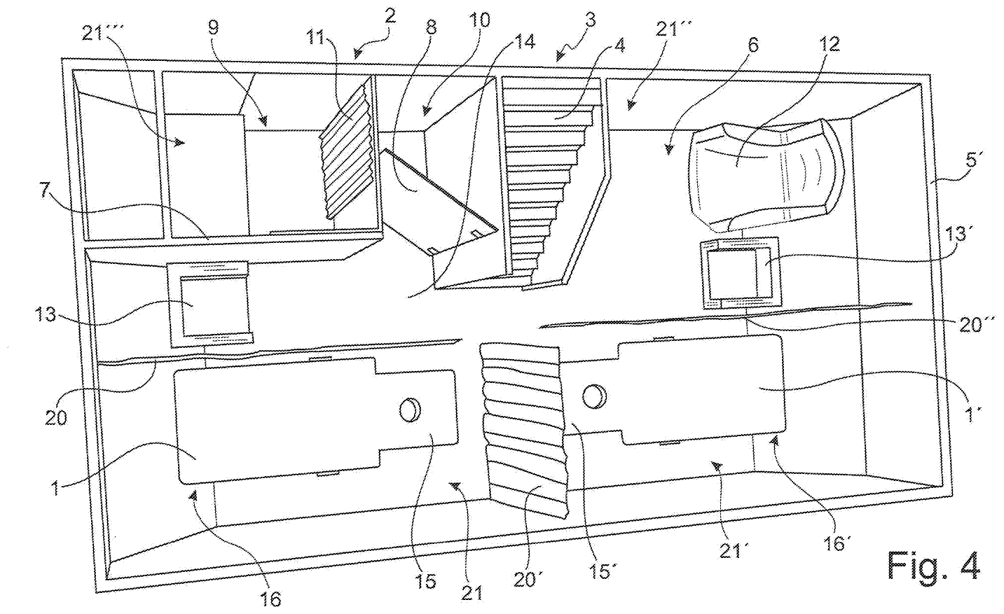

In addition to the preceding FIGS. 1 to 3, FIG. 4 also shows various partitions comprised of curtains 20, which divide the cargo hold module with the massage facility into different sections 21, 21′, 21″, wherein the shower cubicle 2 comprises a separate section 21′″ with a fixed partition wall 7. The curtains 20, 21′ here separate the section 21 with the massage table 1. The curtains 20′, 20″ separate the section 21′ with the massage table 1′. As a consequence, a single respective section 21, 21′ separated from the rest of the massage facility is allocated to the massage tables 1, 1′. The section 21″ comprises the lounge area 6 with the massage chair 12, and allows access to the storage spaces 19. All reference numbers on FIG. 4 here correspond to the reference numbers on the other FIGS. 1 to 3.

All features mentioned in the above specification and in the claims can be combined as desired with the features in the independent claim. Therefore, the disclosure of the invention is not limited to the described or claimed feature combinations; rather, all feature combinations that make sense within the framework of the invention are to be regarded as disclosed.

1. A cargo hold module for an aircraft, in particular a passenger aircraft, with exterior dimensions that are adjusted to a respective cargo hold of the aircraft, and with means that are suitable for securing the cargo hold module in a predetermined position in a cargo hold of the aircraft,
wherein
the cargo hold module has an accessway, via which it can be accessed from a cabin of the aircraft,
the cargo hold module can be hooked up to onboard electrical systems of the aircraft for power, water and/or air supply, and
the cargo hold module has a massage facility with at least one massage table for treating passengers or crew.

2. The cargo hold module according to claim 1, wherein the massage facility of the cargo hold module has sections that can be or are separated from each other.

3. The cargo hold module according to claim 2, wherein at least one section is provided with a massage table, in particular that one massage table is provided per section.

4. The cargo hold module according to claim 1, wherein the massage facility comprises two massage tables which are arranged head to head and transverse to a predetermined flight direction of the aircraft in the cargo hold module.

5. The cargo hold module according to claim 1, wherein the massage table has a head hole at its head end, or the massage tables each have a head hole at their head end.

6. The cargo hold module according to claim 2, wherein one section comprises a shower cubicle.

7. The cargo hold module according to claim 6, wherein the shower cubicle is separated from the rest of the massage facility by means of a partition wall and a door, and divided into a dry area and a wet area.

8. The cargo hold module according to claim 1, wherein the accessway to the cargo hold module is gained from above by way of a staircase.

9. The cargo hold module according to claim 8, wherein the staircase is arranged centrally and in a longitudinal direction of the aircraft inside of the cargo hold module.

10. The cargo hold module according to claim 1, wherein the staircase is arranged between the shower cubicle and a lounge area.
